(19) United States
(12) Patent Application Publication
(10) Pub. No.: US 2011/0093581 A1
(43) Pub. Date: Apr. 21, 2011

(54) Coordinated Computer Network

(76) Inventor: NAVEEN VENKATACHALAM, West Melbourne, FL (US)

(21) Appl. No.: 12/903,339

(22) Filed: Oct. 13, 2010

Related U.S. Application Data
(60) Provisional application No. 61/279,132, filed on Oct. 16, 2009.
(60) Provisional application No. 61/281,566, filed on Nov. 19, 2009.

(51) Int. Cl. G06F 15/173

(52) U.S. Cl. 709/223; 709/238

(57) ABSTRACT

A method for securely obtaining data records over a coordinated computer network having a number of network members, each of which has an internal records database and a node, and a network process computer with an activity database. In a typical transaction, a target node requests an activity record of a subject. If the requested activity record resides on an internal records database belonging to another network member, an activity database is consulted. This is a central store of subject activity indicators that include the location of the activity records. An originator node is the one found to have access to the required activity record. A temporary, secure, transport link established between the target node and the originator node, managed by the network process computer, serves to transfer a copy of the subject's activity record to the target node.

### CLAIM OF PRIORITY

This application claims priority to U.S. Provisional Patent Application 61/279,132 filed on Oct. 16, 2009, and to U.S. Provisional Patent Application 61/281,566 filed on Nov. 19, 2009, the contents of both of which are fully incorporated herein by reference.

### FIELD OF THE INVENTION

The invention relates to a node based coordinated computer network with enhanced data security and transient tunneling capability.

### BACKGROUND OF THE INVENTION

The invention relates to a node based network for securely requesting and furnishing sensitive records. The security exists on both ends of the node based architecture, meaning that both the records and identity of the requesters are secure and undetectable while in transit between two points, usually two or more nodes. The nodal structure also permits exchange of information and authentication that is not usage based, meaning, it is preferably indifferent to how many users are on the node or the network, what records are being requested and what security level is assigned to each record. The nodal architecture is also capable of adapting to a unique or unusual usage requirement.

Most prior art systems rely on large central databases that are difficult and very expensive to implement and maintain. A single database means there is a single point of failure. While a risk of a catastrophic centralized failure may be offset with reliable backups, minors, and multiple instances, individual cites do not have complete control over their flow of data. This also hampers the ability of the prior art systems to adequately adapt to a diverse user base, since everyone is subject to the same type of service. Therefore, many prior art implementations have resorted to exclusive membership networks, where users must comply with standards. However, these standards are often difficult and complex.

On the contrary, the nodal architecture of the present is indifferent regarding the number and types of accounts used by each member. A site is free to implement whatever architecture or set of usage policies are best suited for its mode of operation. However, all network members are capable of conversing with each other, since their communication passes through a designated nodal gateway, which ensures that tunneling protocol and data handling standards are equal and acceptable for all members of the super network.

The super network resides on top of what is now known as the Internet. It is a bundle of security and data collection process that are administered by a common network process. These processes ensure that transient connections are being properly made and timely terminated. The network process is also responsible for ensuring that the all data referenced by indices is properly retrieved and transmitted between nodes. The simplicity of the present invention minimizes costs and eases implementation requirements.

The present invention may be particularly well suited for the healthcare industry, since this industry requires a fast and secure access to patient and doctor records. The complexity of many tasks requires a participation vast and diverse support staffs. At the same time, the industry is charged with a profound and extensive ethical and legal obligation to keep records confidential. To complicate matters further, healthcare is highly segmented into a multitude of providers that operate independently of each other. At the same time, these providers frequently need to interact with one another to request and provide records and other information regarding their patients. However, there are other industries that may benefit from the present invention. These include, but are not limited to law enforcement, intelligence bureaus, private and government security operations, credit and background checking companies, license bureaus, state bar agencies and many others.

### Description of the Related Art

U.S. Pat. No 7,028,182 discloses an assembly and communication of medical information from a variety of modalities to remote stations through a public network is provided for by the combined use of a transmitter and disassembly structure. The transmitter includes an assembly unit for gathering data into packets and a processing unit to provide security for transfer. The disassembly structure reconfigures the data for relay to a receiving station. Mechanisms are provided for conserving the transfer time from transmitter to disassembly structure.

U.S. Patent Application Pub. No. 2009/0164255 discloses a network for mediating the peer-to-peer transfer of digital patient medical data includes a plurality of distributed agents each associated with a health care provider and connected to a central system. Periodically the agents collect local information relating to patient medical files and/or data streams, for example diagnostic images and associated reports, and process that information into metadata files acting as pointers to the original files. The metadata files are transmitted to the central system where they are parsed and the attributes are stored on the central system in patient records with records from the same patient grouped together whenever possible. Registered users can search the central system, even in the absence of a unique identifier, to identify patient records pointing to the remote patient medical files. Upon finding a patient medical file, the invention provides a streamlined process for communicating access authorization from the patient to the hospital or facility storing the medical files. Once patient authorization is received, secure processes are provided for transferring the data in its entirety to or for viewing by the user in a peer-to-peer fashion.

Various implements are known in the art, but fail to address all of the problems solved by the invention described herein. One embodiment of this invention is illustrated in the accompanying drawings and will be described in more detail herein below.

### SUMMARY OF THE INVENTION

The present invention discloses a method for securely obtaining data records over a coordinated computer network.

Typically such a coordinated computer network has a number of network members, each of which has at least an internal records database and a node. The coordinated computer network may also include a network process computer with an activity database.

In a typical transaction, a target node may request a digital copy of an activity record of a particular subject or patient. In a preferred embodiment, as part of security and confidentiality requirements, the coordinated computer network may be configured so that only the node associated with a given network member has access to the records database associated with that network member. If the requested activity record resides on an internal records databases belonging to another network member, the problem is how to securely and efficiently locate and obtain that activity record 54 without jeopardizing either security or confidentiality.

The method of this invention solves that problem by including an activity database in the coordinated computer network. The activity database may be populated with subject activity indicators. These subject activity indicators contain information regarding the location of the activity records, i.e., which network member has the activity record and where on it's internal records databases the activity record 54 resides. In a preferred embodiment, each node has access to the activity database via the network process computer.

Two or more nodes may use this access to initially populate the activity database with subject activity indicators relating to activity records stored on their respective internal records databases.

The access to the activity database 50 may also allow the network members to request activity records from other network member's internal records databases 55 via the network process computer.

As a result of such a request, the target, or requesting, node may initially receive one or more digital data-grams, or data packets, from an originator node. The originator node is a node that has been identified, using a subject activity indicator on the activity indicator database, as having access to an internal records database containing the required activity record.

Having received the initial, transitory communication, a temporary, but secure, transport link may be established between the target node and the originator node. In a preferred mode, this temporary secure link may be managed by the network process computer. Using this temporary, secure transport link, a digital copy of the subject's activity record may be received by the target node from the originator node. Once the target node has received the activity record, the temporary secure transport link may be terminated.

The coordinated computer network may bring the nodes into cooperation with each over the Internet, or another connectivity medium. Such a managed layer over the Internet may be thought of as a super network. This super network is preferably maintained by a network process. The network process may, for instance, be a software module programmed to perform security, data and networking protocols, or some combination thereof. The network process may, therefore, act as managed layer on top of a global computer network. This layer may be in addition to, or included within, one of existing Internet protocol layers. Or it may be a logical embodiment within an application layer that utilizes existing network, data processing and tunneling technology to enable its processes. The super network includes at least one network member. The network member may be controllable to some degree or completely by the network process. Each network member is represented by a node, which may be a single computer system or multiple cooperating computer systems. The node maintains full but localized control of all activities carried out by the network member it represents, as long as the activities are within the scope of the network process. A node functions as a gateway for communication between a network member it represents and the super network. Each node has is capable of adapting to a unique usage or requirement by a network member.

Therefore, the present invention succeeds in conferring the following, and others not mentioned, desirable and useful benefits and objectives.

It is an object of the present invention to provide a super network to facilitate coordinated communication between diverse members of an industry.

It is another object of the present invention to provide a common network process to manage and administer a super network.

Yet another object of the present invention is to provide a nodal architecture that permits network members the flexibility of maintaining control on local records processing.

Still another object of the present invention is to provide a coordinated network capable of tracking each subject records in a secure, accurate and non-data intensive way.

Still another object of the present invention is to provide a nodal architecture that enables each network member to maintain user accounts independently of the network process.

Yet another object of the present invention is to provide a nodal architecture where each node functions as a gateway between the network process and all local records activity.

Still another object of the present invention is to provide a nodal architecture for a coordinated computer network that may be scaled between one and many physical computer systems.

Yet another object of the present invention is to permit user authentication that is managed by the network process, thus requiring only a single authentication per session for most super network wide activity.

It is still another object of the present invention to provide a coordinated computer network that does not require a central database or a central front end management server.

It is yet another object of the present invention to provide a coordinated computer network where the network process maintains secure communications over the network, also herein referred to as bridges, and then ensures that the bridge is removed and eliminates any residual trace of communication upon consummation of the data exchange between nodes.

It is still another object of the present invention to provide a coordinated computer network were nodal software is generic and thus capable of adapting to a diverse user base of individual network members.

### BRIEF DESCRIPTION OF THE DRAWINGS

FIG. 1 is a flow diagram of the overall inventive application of the present invention.

FIG. 2 is a detailed flow diagram of the network and member relationship.

FIG. 3A/B illustrate methods of secure communication embodied in the present invention

FIG. 4 is a detailed diagram describing a record assembly from multiple subject activity indicators.

FIG. 5 is a detailed diagram of components of a computer system.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

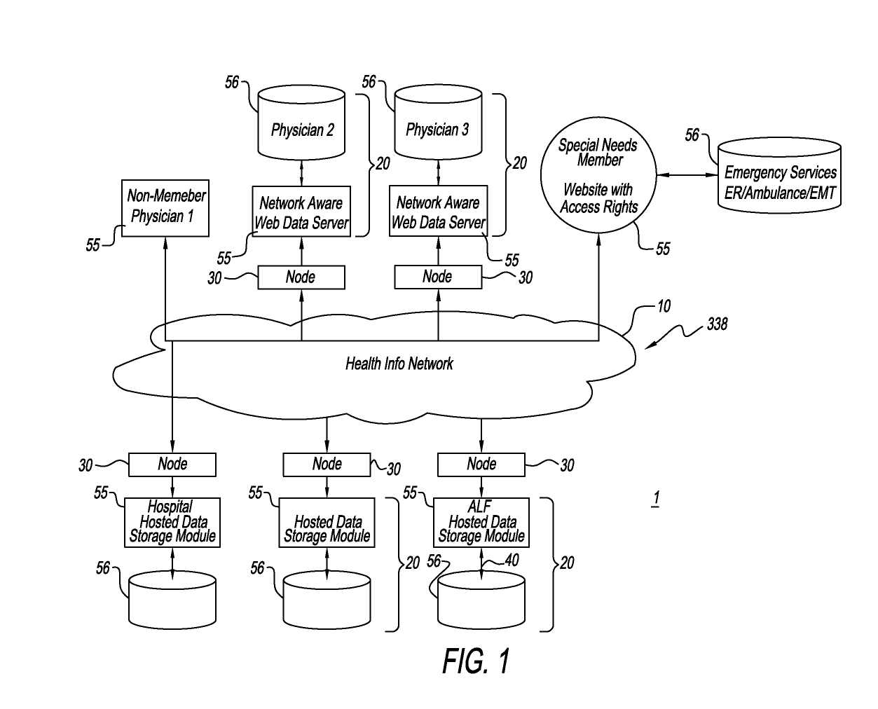

FIG. 1 shows an overview flow chart of the coordinated computer network 1 of the present invention. The coordinated computer network 1 is used to facilitate fast, reliable and secure sharing of records over any suitable networked environment.

The coordinated computer network (CCN) 1 includes a super network 10 managing a number of nodes 30, each of which serves as a gateway to a network member 20. The super network 10 may include processes that may function as a managed layer on a global computer network 338. Each network member 20 may perform one or more member activities 40.

The coordinated computer network may also be enabled over a private computer network such as a local area network (LAN) or a wireless network (Wifi). The present invention may also be enabled over a phone network, or any digital or analog connection. A preferable embodiment of communication is over the Internet, a.k.a. the World Wide Web that connects one network member 20 with another. The data being exchanged is preferably segmented into data-grams, also known as packets, and sent to a destination over the web. The data may also be sent in a continuous, uninterrupted stream, using TCP/IP or UDP protocols, and either via unicast, multicast, broadcast, or any other means of disseminating information electronically or via radio frequencies.

The nodes 30 of the coordinated computer network 1 may include one or more software modules programmed to run on one or more computer systems. The software module may initiate or enable requests for data records that may be stored centrally on, or within, a network accessible by that node 30, or on, or within, another network belonging to a network member 20.

FIG. 1 illustrates the coordinated computer network 1 that ties together multiple nodes 30. In turn, the nodes 30 send packets to and from internal computer servers 56 that may be connected to internal records databases 55.

In an alternative embodiment, the software enabling a computer to function as a node 30 may be loaded directly onto an internal computer server 56, thus enhancing the capability of a user's existing information technology infrastructure. A network member 20 may additionally be referred to as an electronic member/medical resource (EMR) and may have a state of being a full member, meaning that it is both technologically and statutorily compliant. An EMR may also be a non-member meaning that it is either technologically or statutorily not fully compliant with membership requirements of the super network 10. Statutory compliance may mean compliance with any privacy or secrecy regulation.

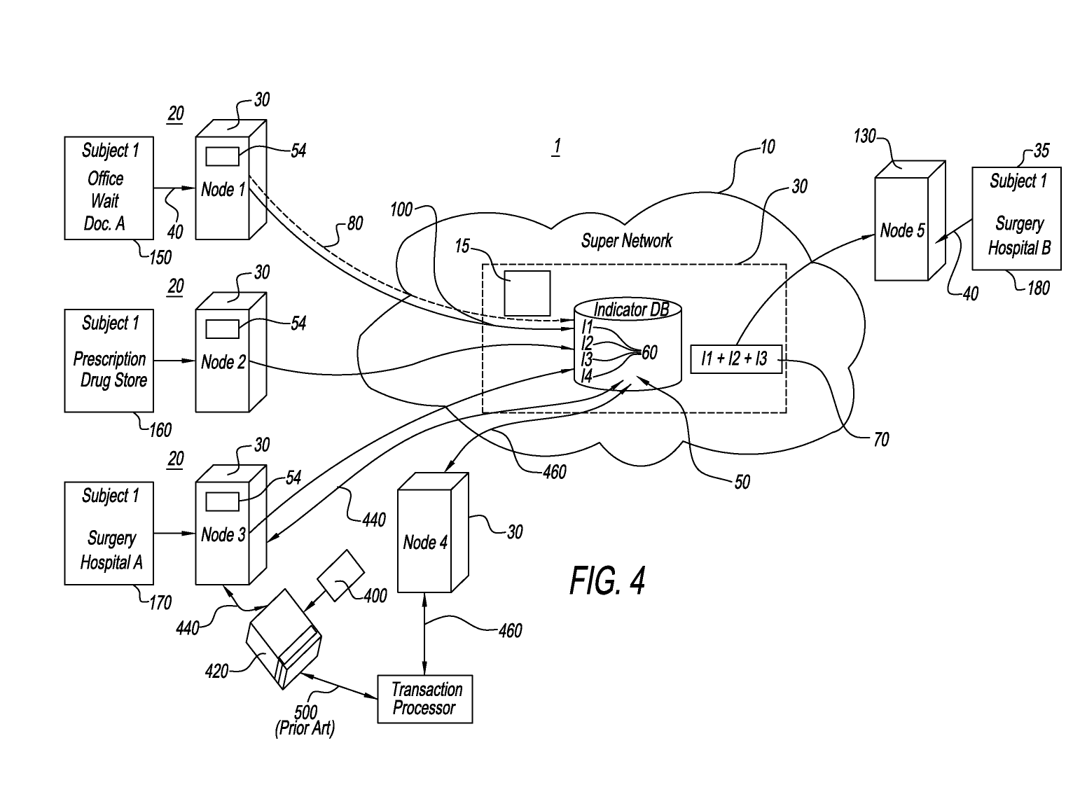

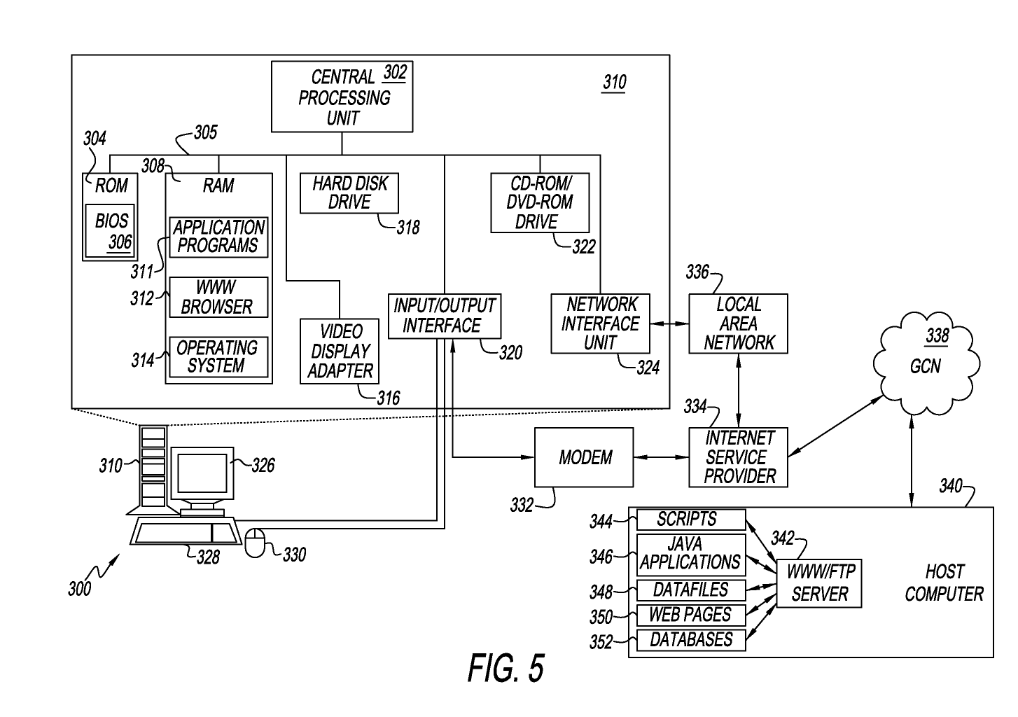

The term “a node” 30 may refer to an appropriately equipped and programmed physical computer, as described herein in FIG. 5. The term may also or instead, refer to a stand-alone software application that may be running within one physical computer or spread across several computer systems. A node 30 preferably includes software such as a server process 140 (FIG. 4) that includes all of the necessary instructions, system calls and libraries to be able to manipulate hardware resources, such as hard disk drives 318, or random access memory (RAM) 304, or operating system resources 314, IO interfaces 320 or network adapters 324. Alternatively, the node 30 may be written within an application server, such as, but not limited to Red Hat Jboss, Oracle Weblogic™, or IBM Websphere™. In such an embodiment, the node 30 may contain business logic necessary to enable the gateway functionality and secure communication between a network member 20 and the coordinated computer network 1, while all of the standard hardware and inter-process calls may be handled by the application server.

The node 30 may also be split into a client tier and the server tier, where either may be written for any operating system 314, which may be the same, or different, between the client tier and the server tier. For example, the client tier may compiled to run in Windows CE™, for data input done through a personal digital assistant (PDA), while the server tier may be compiled to run on a UNIX™ or a Linux™ platform. The operating system 314 for different tiers may be interchangeable. In such an embodiment the client tier, also known in the art as a front end, of the node 30 may provide service and administrative menus, while the server tier of the node 30 may provide all of the actual data and access processing, and may be configurable by the client tier. These tiers may reside on separate or the same computer hardware, for example, separate or the same CPUs 302, with connectivity done over TCP or RPC sockets and system calls, or directly over inter-program function calls, for example if the entire computer code of a program is loaded in the runtime segment within memory 305.

In an alternative embodiment, the software enabling the functionality of a node 30 may be enclosed in a web server, such as, but not limited to an Apache or an iPlanet powered web server. The business logic would then be encapsulated and created to operate within the parameters of a web server and accessed from a specific port, network, and/or directory path.

The coordinated computer network 1, also referred to as the super network 10, preferably contains managing software. The managing software may reside on a central node 30 or on each of the individual nodes 30. The software for the managing layer preferably includes at least two parts, one operating from within the application layer as described by the Open System Interconnection (OSI) model, or by the Internet Protocol Suite (IP) model, and another part being a tunneling software, and operating from within the Transport layer in the OSI model or the link layer with IP model.

One skilled in the art will appreciate that the application layer may be configurable or controlled from an operating system shell or via a web interface and accessed by a browser, such as Internet Explorer or Mozilla. The application part is preferably capable of controlling the tunneling part. Alternatively, either the application part or the tunneling part may be provided by the managing software, with the configuration, access, or linking being performed by standard operating system 314 processes. The tunneling part refers to the transient secure transport described herein, which is preferably encrypted, and may extend to other forms of secure communication whether or not compatible with the spirit of the tunneling paradigm.

If the coordinated computer network's 1 management functionality is spread amongst the individual nodes 30, there is preferably a syncing mechanism provided to ensure that all nodes 30 are enabling the coordinated computer network 1 in unison and there is not a dichotomy of events or user actions. In one embodiment, such cooperating management of the coordinated computer network 1 may be carried out by sectioning the web into segments, each of which may be assigned to a different node 30. Alternately, each node 30 may be able to determine how to communicate with any other node 30.

As illustrated in FIG. 1 the nodes 30 are gateways that receive and dispatch data to and from the super network 10. The present invention is shown in a preferred setting of a health network. However, the spirit of the present invention may be suited for application within other settings, such as but not limited to law enforcement, security, or background checking of all kinds.

In the preferred implementation of the present invention, the individual network members 20 may, for instance, be hospitals, nursing homes, drug stores, or rehabilitation centers. Other network members 20 may have differing or special needs, for example the Emergency Room, may have a need to access patient records without obtaining an authorization from the patient. In another example, healthcare providers that are not participating within the network may still be able to furnish or receive patient records from members. In such cases, a gateway functionality of the node 30 may require additional or alternative authentication procedures or be capable of indirect communication, for example through automated generation of email messages, physical written communication and audio messaging.

Preferably the software enabling a node 30 may function to generate, or otherwise process, a patient, a.k.a. subject, consent form. Such a form may be used to obtain a patient's consent to gain access to private records from a different provider, a.k.a. another network member 20. The nodal software within a node 30 may override the consent requirement with additional or alternative authentication steps in circumstances where obtaining a subject's consent is either undesired or impractical.

The coordinated computer network 1 preferably utilizes the existing link or transport or physical layers of the existing Internet. However, to increase security, the present invention's network process 15 preferably establishes the temporary secure transport link 100 using a tunneling protocol such as, but not limited to, level 2 tunneling protocol (L2TP) or secure shell (SSH). One skilled in the art will be able to appreciate how these protocols accomplish a tunneling capability. Furthermore, the network process 15 (FIG. 4) ensures that all temporary secure transport link 100 formed via tunneling connections are properly terminated rather than lingering indefinitely.

The coordinated computer network 1 may include interoperability between two types of data storage facilities, mainly, the activity database 50 and the internal records databases 55. The latter may be ancillary to the present invention, and may be used by individual network member 20 to store their subject records. Therefore, in the preferred embodiment, the internal records databases 55 may be consist of patient records for individuals treated by this network member 20. Such a records database 55 may be a proprietary or a commercially available database implementation, such as Oracle™, DB2™, Sybase™ or a SQL Server. In contrast, the activity database 50 is preferably populated with unique indicators, such as, but not limited to, subject activity indicators 60 (FIG. 4). A subject activity indicator 60 may also be referred to as subject event identifier. Each subject activity indicator 60 may be an address, or link, to an activity record 54 that may be a specific patient record. This activity database 50 may be centrally located within the super network 10 or may be locally present on every node 30. The activity database 50 may be distributed across each node 30 as metadata by the network process 15. The metadata may be in form of a list. The metadata may be complete or partial and related just to the activities of that particular node 30.

In a local embodiment of the activity database 50, an update of entries may be accomplished in several ways, for example by searching each node 30 for a more up to date version of the activity database 50 or by loading a static version of a activity database 50 from a static location and then keeping it dynamic on each node 30, with periodic synchronizations among all nodes 30 and a centrally located activity database 50.

Once an identity indicator or a subject activity indicator 60 has been created the network process 15, or the nodes 30, may track each subject 35, keeping an accurate listing of all activity indicators 60 relating to that subject 35. This may be enabled if, for example, a billing software common in the art automatically assigns a subject tracking identifier or an identity indicator to this subject. Subsequently, the records documenting work related to a particular subject 35 may be updated with the latest work or other activity related to this subject 35. Alternatively, the nodal software may contain software hooks, into a particular billing, tracking or diagnostic software, so that the software on a node 30 and/or activity database 50 is updated automatically. These software hooks may be enabled through an application programming interface (API), by compiling the software for node 30 with a compatibility library for that tracking or billing software, or in a servlet based mechanism such as JavaBeans, or through any other means known in the art to function as a means of activating a software's capability by an external process.

A unique subject activity indicator 60 may be assigned to each subject 35 and to each activity attributed to that subject 35. In a preferred embodiment, a subject activity indicator 60 may be associated with an activity record 54 that memorializes a treatment provided to a subject 35 or is a medical record regarding a condition of that subject 35. In a further embodiment, a subject activity indicator 60 may be associated with an activity record 54 that is a record of a service, such as, but not limited to, an insurance or financial service associated with the subject 35, or an event involving the subject 35 such as, but not limited to, a prior surgery. The subject's 35 activity records 54 may be stored locally within a records database 55 of any network member 20. A subject's 35 activity records 54 stored in a network member's 20 internal records databases 55 preferably include all the activities performed for the subject by that network member 20. The activity record 54 within the records databases 55 may be of any size necessary to store the necessary information including, but not limited to, any relevant digital X-ray or other images. By contrast, the subject activity indicators 60 are merely flags, address indices, or pointers to where the activity records 54 are located. Therefore, the subject activity indicators 60 do not require a great deal of disc space, or other suitable digital storage medium space. For this reason the activity database 50 may be located centrally on the super network 10, or they may be stored centrally and periodically uploaded to each node 30 individually, or they may be independently stored on each node 30. Any other efficient storage of the subject activity indicators 60 may be possible. The complete or partial listing or database of the subject activity indicators 60 may be loaded into random access memory (RAM) 304 of all or some of the nodes 30 or of a central node 30 (not shown).

Each node 30 preferably serves as a gateway, linking the super network 10 with each network member 20. The node 30 may double as a firewall since it is capable of serving as a proxy between the messages on the super network 5 and all internal activity within the network member 20. Alternatively, the node 30 may function in conjunction with or subject to an external firewall or internal firewall software. Each node 30 preferably supports all member activities 40, which may also be referred to as nodal activity. Member activity 40 may include, but is not limited to, user access, an access privilege (which records may or may not be viewed by a particular user account 90), a record request using an indicator, a record upload, a record download, a notification, such as a notification to open a temporary secure transport link 100, or a secure transport or any combination thereof.

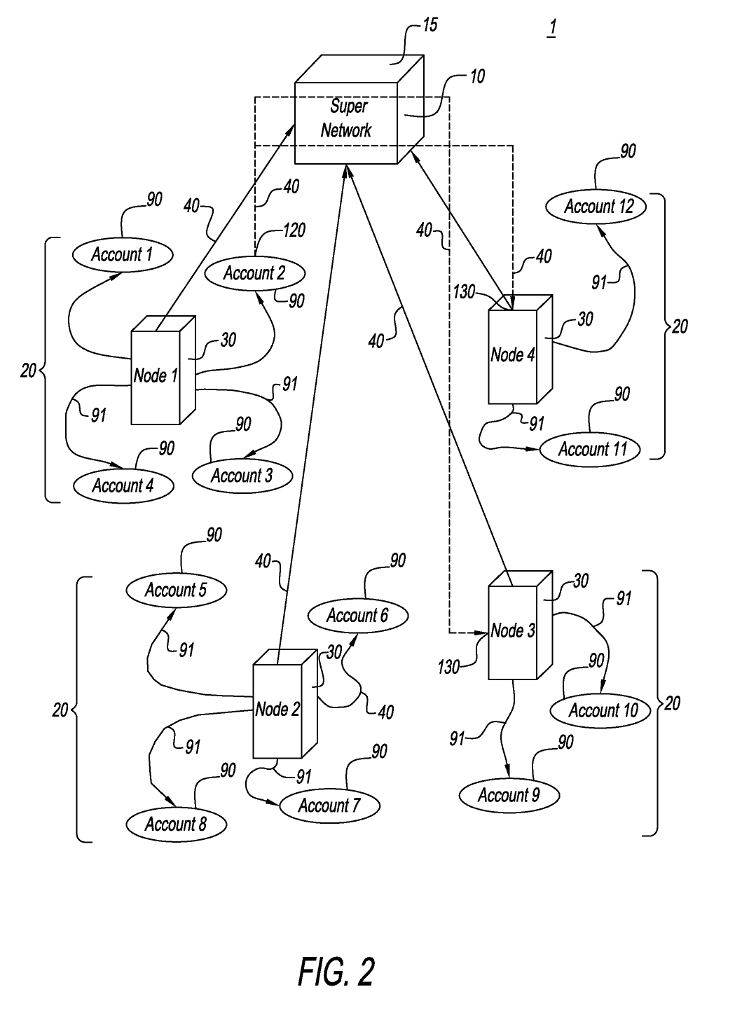

FIG. 2 shows a more detailed flow diagram illustrating how an individual user or an account relates to the overall CCN 1. Shown in this figure are a coordinated computer network 1, a super network 10, a network member 20, a node 30, a member activity 40, a user account 90, user access 91, a temporary secure transport link 100, an originator node 120, and a target node 130.

Each node 30 servers as a front end of the network member 20 associated with it. The nodes 30 receive all traffic to and from the super network 10. Each node 30 also preferably manages an internal user access 91 for the network member 20 it represents. The most rudimentary embodiment of an internal user access 91 is a user account 90. Internal user access 91 may be further distinguished based on access, duration and viewership privileges. For example, a physician may be permitted to access the full medical history of any subject by using their physician user accounts. A medical biller in the same office may, however, only be able to view the subject's prior visits or visits with other providers. In a different embodiment, a director of an investigative agency may be capable of viewing records of any subject, while an individual inspector may only be able to view subject information relating to cases they are assigned to.

In an alternative embodiment a node 30 may be responsible for creating and maintaining the user accounts 90, while individual security policies or user account roles would be dictated centrally by the network process 15 (FIG. 4). To this extent a user account 90 may be enabled by a login name/password combination, some other data entry combination, or through a fingerprint or retinal scan, while other access and viewership privileges may be set by the network process 15 in accordance with various authentication and enforcement requirements dictated by local and federal rules and statutes.

Additionally a user account 90 may represent activities of a billing application, or a diagnostic, reporting or a tracking application or some other application that creates uses or tracks a subject, and subject related activities. The user account 90 assigned to such an application preferably automatically updates the network process 15, via the node 30, with activity related to a particular subject. The network process 15 may in turn assign a subject activity indicator 60 to this subject or subject activity and update the activity database 50. Alternatively the software within the node 30 will assign the subject activity indicator related to the subject and update the activity database 50, via the network process 15, with information regarding this new assignment.

It is preferable that, apart from the initial authentication of the user account 90, details of the temporary secure transport link 100 established between nodes 30 is hidden from users when they are obtaining records. Although a request may involve an exchange of data between two or more nodes 30 that may function as security proxies, this is preferably not discernible from a user account 90.

It is preferably that a node 30 will first notify the network process 15 of any pending send and receive action. Then either the node 30, or the network process 15 running on the network process computer 11, performs an encapsulation of the data to in accordance with security and tunneling specified by the present invention. Once encapsulated, the data may be sent over the super network 10 from the originator node 120 to the target node 130. The node 30 that functions as the target node 13 for the purposes of this particular transmission then unpacks the requested activity record 54 and forwards it to a user account 90 that is best capable of responding to the request, or which requested this activity record 54. Since the data may be private or restricted, the node 30, or the network process 15 running on the network process computer 11, may present a consent form or a screen to the requesting or dispatching user account 90. The transmission will preferably fail, with or without an error message to the parties involved in an event, when a proper consent, authentication or both has not been supplied, or if a software or hardware problem has been encountered while communicating the information. Any node 30 may simultaneously function as the originator node 120 and as a target node 130. A node 30 is not limited by the number or type of accounts that are implemented for a particular network member 20. Rather, resources offered by the super network and funneled through a node 30 may be shared by all accounts.

The network process 15 running on the network process computer 11 is, preferably, responsible for opening a temporary secure transport link 100 between the originator node 120 and the target node 130 and for terminating the temporary secure transport link 100. Also, the network process 15 is preferably responsible for maintaining a activity database 50 of subject activity indicators 60 and any subject identifiers representing each subject. In such an embodiment the network process 15 may link the subject activity indicator 60 and any subject identifier representing the subject 35. For example, a subject identifier may be a random number stored on a records database 55. A drug store prescription request may be stored on another records database 55. Both of these records are assigned a subject activity indicator 60 and properly associated within the activity database 50 by the network process 15 or by each node 30. The network process 15 may then be dynamically notified by the nodes 30 of any changes regarding the subject activity indicators.

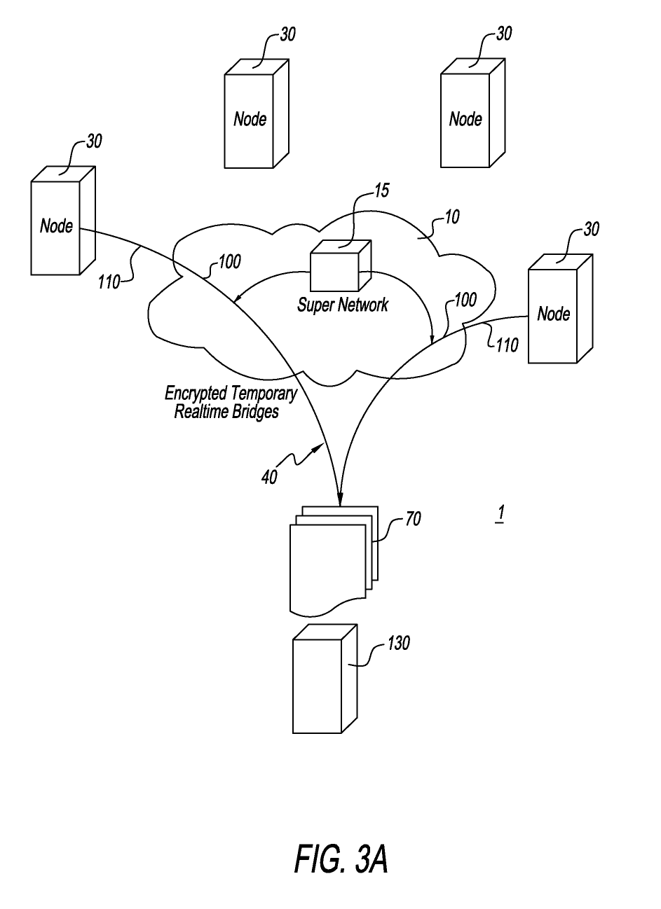

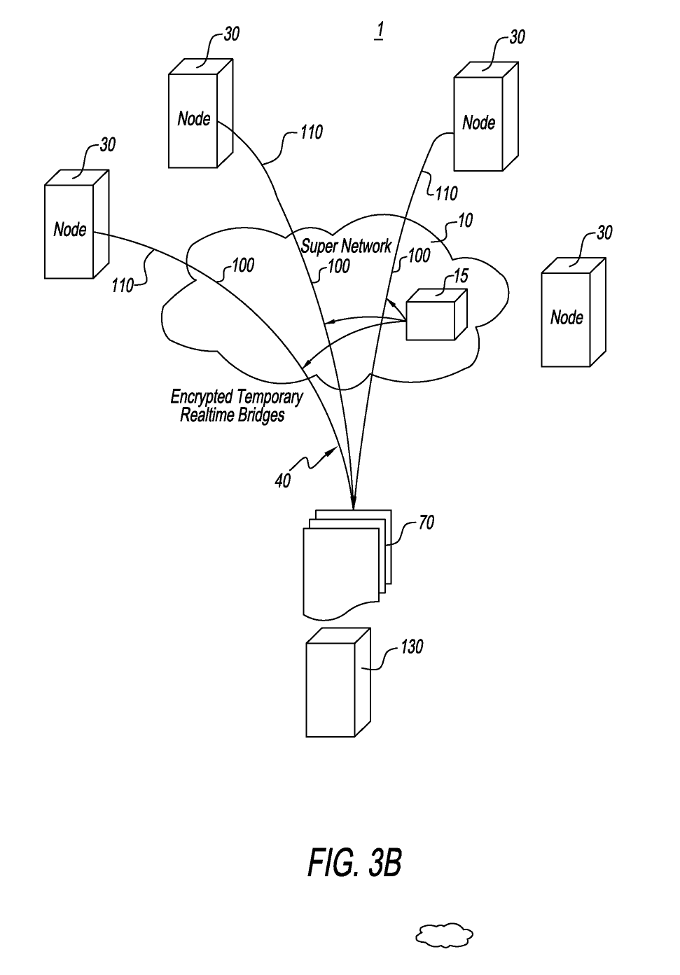

FIGS. 3A and 3B illustrate the transient nature of the nodal communications embodied in the present invention. Shown are a coordinated computer network 1, a super network 10, a node 30, a member activity 40, a complete record 70, a secure transport 100, a transitory passage 110, an originator 120, and a target 130. The complete record 70 may also be referred to as a subject event record. The flowchart illustrates the temporary secure transport link 100 that may be opened up through the super network 10. Each complete record 70 of a subject, which may be a complete patient record, may be broken into a series of services or other events, each of which may be identified in the activity database 50 by a subject activity indicator 60. Each subject activity indicator 60 may be an address of where and how to find an actual segment, or activity record 54, of a subject's record.

As shown in FIG. 2, an activity record 54 may be requested from a node 30 having access to that particular activity record 54. If proper authentication or a consent are obtained, a node 30 may open a transitory passage 110, which is a transient connection that is only active long enough to send at least one datagram to the target 130. The network process 15 may then open a temporary secure transport link 100 through the super network 10. Alternatively, both the transitory passage 110 and the temporary secure transport link 100 may be managed by the network process 15 running on the network process computer 11. The activity records 54 are then preferably assembled by a node 30 that is functioning as a target node 130 during this transmission. The transitory passage 110 and the temporary secure transport link 100 may be referred to as a bridge of a temporary nature, and, for example, may be an encrypted temporary real time bridge.

In an alternative embodiment, activity records 54 regarding a specific subject 35 may be requested by a unique subject identifier. The network process 15 may then utilize the subject activity indicators 60 associated with the unique subject identifier to access each node 30 of a network member 20 where the record represented by that particular subject activity indicator 60 may be stored. The information retrieved may then be assembled by the network process 15 running on the network process computer 11 into a complete record 70 and sent to the target node 130.

Alternatively, a complete record 70 may be assembled by the requesting the target node 130 based on the list of subject activity indicators 60 sent to it by the network process 15. The target node 130 may then function as an originator node 120 to request the each record represented by each subject activity indicator 60 from an appropriate node 30 and then assemble all records into a complete record 70. In all embodiments, the subject activity indicator 60 specifies where the actual activity record 54 is stored.

FIGS. 3A and 3B illustrate that all of the communication between nodes 30 occurs over temporary secure transport links 100 that are preferably initiated by the network process 15 in response to a request of from node 30. Alternatively, the temporary secure transport link 100 may be opened by any individual node 30 without the participation of a network process 15. The temporary secure transport link 100 may preferably utilize tunneling protocols, also referred to as transient passage protocols, such as, but not limited to L2TP, SSH, SHTTP, or SSL or any other transient passage protocol known in the art and or similar in functionality to the aforementioned tunneling protocols. The transport, which includes both the temporary secure transport link 100 and the transitory passage 110 may be transient, meaning they terminate as soon as there is a lapse in communication, as soon as when one of the network member 20 becomes unresponsive, or if the communication request has been satisfied, such as when at least one datagram has been sent and/or a successful acknowledgement has been received from a target node 130. Each node 30 or a network process 15 may function as a place holder or a state process that would restart the transport at the point where it terminated. Alternatively, the transient nature would mean that once a connection is terminated all communication has been eradicated and anything that has not yet been transmitted or has been transmitted with an error, will now require compete or partial retransmission.

The use of subject indicators 60 rather than full records preferable because they are more secure than transferring a full encrypted record 70. The use subject activity indicator 60 instead of actual records promotes anonymity of the subject records since the subject activity indicators 60, if intercepted, will represent untraceable arbitrary blocks of data.

It may be preferred that the actual subject activity indicators 60 do not contain information that relates them to one another. Rather, linking information may be stored separately by the network process 15 or by individual nodes 30. Alternatively, each subject activity indicator 60 may contain information that directs the node 30 or the network process 15 to obtain the next correct activity record 54.

Referring now to FIG. 4 shown are a coordinated computer network 1, a super network 10, a network process 15, a network member 20, a node 30, a member activity 40, an activity database 50, a subject activity indicator 60, a complete record 70, a temporary secure transport link 100, a transitory passage 110, an originator node 120, a target node 130 and a server process 140.

FIG. 4 shows a detailed diagram of how a complete record 70 may be assembled from individual subject activity indicators 60 for the target node 130. The subject, the patient, may, for instance, have been seen by a physician A 145 for indigestion. Physician A 145 may be a network member 20. When entering the subject's name and other credentials, a subject activity indicator 60, or alternatively a unique subject identifier 80 is created as an initial step. Either indicator may be automatically or selectively created and sent by a temporary secure transport link 100 to the network process 15. Alternatively, the network process 15 that may enable or authorize a temporary secure transport link 100. The subject activity indicator 60 may be stored within the activity database 50, which may be centrally located on a central node 30, within the super network 10, or which may be maintained by or uploaded onto each node 30, individually.

Subject activity indicators 60 may be created dynamically by the network process 15, or by a node 30 where the activity originated, as soon as a related activity occurs, provided that the activity was carried out by a network member 20. For example, when the subject visits a drug store 160 to fill a prescription, an activity record 54 may be stored locally on an internal records database 55 associated with a first node 30. A subject activity indicator 60 associated with the activity record 54 may then be created and transmitted to the activity database 50 on the network process computer 11 running the network process 15. Similarly, when the subject has a surgical procedure performed at the hospital A 170, an activity record 54 memorializing this may be stored on a \. Subsequently, the subject approaches hospital B 180 or a different surgery. The hospital B 180 is preferably a network member 20 and uses a member activity 40 to request a complete record 70 of this subject's prior medical record. A complete record 70 is then assembled by the network process 15 centrally and sent to the target 130, or a complete record 70 is requested by the target 130 based on a list of subject activity records the target receives from the database 50, or the network process 15 assembles a complete record 70 within the target 130, based on the listing of the relevant subject activity indicators it received from the database that were related to the subject, either by a unique identifier (not shown) or by other means, including another subject activity indicator 60.

In the preferred application of the present invention, the subject of the activity indicator 60 may be a patient, while a user of the node 30 may be a healthcare provider. A patient or any subject having a legally protectable right to privacy right would authorize access to records as an initial step. Such authorization may occur implicitly, when a patient visits a healthcare facility to fill out the necessary documentation or explicitly, when a patient consents to a provider's access of patient's records 70.

For example, in steps 150, 160 and 170 a healthcare provider would likely benefit from a review of a patient's prior medical or treatment history. Therefore, the subjects in items 150, 160 and 170 would be asked to grant authorization to the provider to obtain records 70.

In the present state of the art there is currently no direct link between the records 70 pertaining to the subject 1 and the transactional records that are necessarily kept by a network member 20. A network member 20 typically addresses the transactional part as an ancillary step. For example, a healthcare provider or any other subscriber that would fit within the rank of an EMR, would request some method of payment or accountability and will begin processing the payment or recording the transaction. In the present state of the art, the typical transaction would entail a processing of a subject's credit card, or even more likely, the insurance provider card 400 through a card reader 410, which may be separate from or a function of an existing computer system operated by the network member 20. At this point, the prior art system would forward this transaction to the issuer of the cart to process the transaction. This step is illustrated in FIG. 4 as item 500. Similarly, a healthcare provider will need to be aware of any referral or supplementary fees and information that are relevant or which are imposed by particular card issuer, also known as the transaction processor 430. Since there is presently no direct link between records 70 and the transactional part 500, a network member 20 is still required to do a great deal of manual processing to reconcile the automated super network 10 and the transactional ends.

The card issuer or the transaction processor 430 may refer to a health insurance provider, a dental insurance provider, or a business records and transaction processor. The present invention is capable of absorbing the transactional processor 430 into the category of network members 20 and thus streamlines the record acquisition 40 and transaction processing 500 into a single member activity 440. Note that the card readers, existing billing software, and other existing devices may remain unchanged. However, the technique for updating the transaction processor 430 is now absorbed into the network activity 40, where it can become an integral part of the record 70 or at least be in a close collaboration with the record 70.

An example of a process by which this would function may be illustrated as follows, although many other benefits and efficiencies are likely to arise from the disclosed collaboration over the super network 10. The transaction step 440 would preferably occur in the background. For example a physician who is part of the hospital “A” 170, which is an EMR, may be referring a subject to another facility for further treatment, or may be admitting the subject pursuant to a referral. The present invention may automatically enable this physician to obtain all relevant referral information from the transaction processor 430, such as an insurance company, which is associated with the present subject or patient. This process may occur automatically as a background process, for example, as soon as the subject activity indicator 60 is entered into the node 30, or it may occur as one of the primary processes, such as when deliberately requested by a user account 90. The transaction processor 430, functioning as another network member 20 would communicate with the super network 10 through the node 30, to receive the subject activity indicator 60 assigned to the subject, obtain complete record 70, as needed, and respond with appropriate referral or other transactional information. Therefore, a facility 170 may not only obtain the records 70, but would be capable to also addressing all of the essential transactional information that presently occurs as a separate and disjoined process.

In another example, a requesting EMR 20 refers a patient to another EMR 20, or even to a non EMR, the super network 10 implementation may permit an automatic authorization of a referral from the requesting EMR 20, by an insurance carrier that is represented in the super network 10 as another EMR 20. Such an exchange is highly desirable for expensive, but time sensitive referrals, such as, but not limited to MRI or Ultrasound.

The inclusion of the transaction processor 430 may be enabled in many ways. One of the preferred methods is to have the network process 15 direct the network activity 40 to request not only the complete record 70, but also the transaction information 460 from the transaction processor 430. Therefore, the node 30 for the facility “A” 170 will automatically receive a record of all subject activity indicators 60, which may include a location of where to obtain the subject's insurance or transaction processing information 430. To support this functionality the database 50 may be expanded to store unique transactional identifiers 60 that identity transactional information, or transactional information may be stored in a separate database that can be accessed by the network process 15. Alternatively, the processing may be handled by the server process 140 that may run on each node 30, which may handle transactional information 460 in conjunction with the member activity 40. Whether centrally evaluated by the network process 15 or locally handled by the server process 140, the subject activity identifiers 60 assigned to subjects or assigned to transactions may be linked at the database level or at the processing level (with the network process 15 or the server process 140), and be handled by the nodes 30 as part of the overall record 70 or as a separate record.

To accommodate the existing equipment and computer software that currently handle transactional activity, the present invention may contain drivers, which may be a set of libraries having instructions on how to interact with each hardware or software adaptation, or it may be a set of adaptations or “hooks” created for the particular prior art software or equipment, so that a signal or message from a prior art device is converted into a request by an account 90 that is channeled by the node 30 into the super network 5 and that responses from the super network 5 are translated back into a signal or format that can be understood by the prior art device or software. Essentially the server process 140 or the network process 15 achieves backward compatibility by functioning as a translation bridge between the old or existing technology and the concepts espoused by the present invention.

FIG. 5 and the following discussion are intended to provide a brief, general description of a suitable computing environment in which the invention may be implemented. Referring now to FIG. 3, an illustrative environment for implementing the invention includes a conventional personal computer 300, including a computer processing unit 302, a system memory, including read only memory (ROM) 304 and random access memory (RAM) 308, and a system bus 305 that couples the system memory to the central processing unit 302. The read only memory (ROM) 304 includes a basic input/output system 306 (BIOS), containing the basic routines that help to transfer information between elements within the personal computer 300, such as during start-up. The personal computer 300 further includes a hard disk drive 318 and an optical disk drive 322, e.g., for reading a CD-ROM disk or DVD disk, or to read from or write to other optical media. The drives and their associated computer-readable media provide nonvolatile storage for the personal computer 300. Although the description of computer-readable media above refers to a hard disk, a removable magnetic disk and a CD-ROM or DVD-ROM disk, it should be appreciated by those skilled in the art that other types of media are readable by a computer, such as magnetic cassettes, flash memory cards, digital video disks, Bernoulli cartridges, and the like, may also be used in the illustrative operating environment.

A number of program modules may be stored in the drives and RAM 308, including an operating system 314 and one or more application programs 310, such as a program for browsing the world-wide-web, such as a WWW browser 312. Such program modules may be stored on a hard disk drive 318 and loaded into RAM 308 either partially or fully for execution.

A user may enter commands and information into the personal computer 300 through a keyboard 328 and pointing device, such as a mouse 330. Other control input devices (not shown) may include a microphone, joystick, game pad, satellite dish, scanner, or the like. These and other input devices are often connected to the processing unit 300 through an input/output interface 320 that is coupled to the system bus, but may be connected by other interfaces, such as a game port, universal serial bus, or fire-wire port. A display monitor 326 or other type of display device is also connected to the system bus 305 via an interface, such as a video display adapter 316. In addition to the monitor, personal computers typically include other peripheral output devices (not shown), such as speakers or printers. The personal computer 300 may be capable of displaying a graphical user interface on monitor 326.

The personal computer 300 may operate in a networked environment using logical connections to one or more remote computers, such as a host computer 340. The host computer 340 may be a server, a router, a peer device or other common network node, and typically includes many or all of the elements described relative to the personal computer 300. The LAN 336 may be further connected to a GCN service provider 334 (“ISP”) for access to the GCN 338. In this manner, WWW browser 312 may connect to a host computer 340 through a LAN 336, ISP 334, and the global computer network 338. Such networking environments are commonplace in offices, enterprise-wide computer networks, intranets and the global computer network 338.

When used in a LAN networking environment, the personal computer 300 is connected to the LAN 336 through a network interface unit 324. When used in a WAN networking environment, the personal computer 300 typically includes a modem 332 or other means for establishing communications through the GCN service provider 334 to the global computer network 338. The modem 332, which may be internal or external, is connected to the system bus 305 via the input/output interface 320. It will be appreciated that the network connections shown are illustrative and other means of establishing a communications link between the computers may be used.

The operating system 314 generally controls the operation of the previously discussed personal computer 300, including input/output operations. In the illustrative operating environment, the invention is used in conjunction with Microsoft Corporation's “Windows 98™” operating system and a WWW browser 312, such as Microsoft Corporation's global computer network 338 Explorer™ or Netscape Corporation's global computer network 338 Navigator™ operating under this operating system. However, it should be understood that the invention can be implemented for use in other operating systems, such as Microsoft Corporation's “WINDOWS 3.1™,” “WINDOWS 95™”, “WINDOWS NT™”, “WINDOWS 2000™”, “WINDOWS XP™” and “WINDOWS VISTA™” operating systems, IBM Corporation's “OS/2™” operating system, SunSoft's “SOLARIS™” operating system used in workstations manufactured by Sun Microsystems, and the operating systems used in “MACINTOSH™” computers manufactured by Apple Computer, Inc. Likewise, the invention may be implemented for use with other WWW browsers known to those skilled in the art.

Host computer 340 is also connected to the GCN 338, and may contain components similar to those contained in personal computer 300 described above. Additionally, host computer 340 may execute an application program for receiving requests for WWW pages, and for serving such pages to the requestor, such as WWW server 342. According to an embodiment of the present invention, WWW server 342 may receive requests for WWW pages 350 or other documents from WWW browser 312. In response to these requests, WWW server 342 may transmit WWW pages 350 comprising hyper-text markup language (“HTML”) or other markup language files, such as active server pages, to WWW browser 312. Likewise, WWW server 342 may also transmit requested data files 348, such as graphical images or text information, to WWW browser 312. WWW server may also execute scripts 344, such as CGI or PERL scripts, to dynamically produce WWW pages 350 for transmission to WWW browser 312. WWW server 342 may also transmit scripts 344, such as a script written in JavaScript, to WWW browser 312 for execution. Similarly, WWW server 342 may transmit programs written in the Java programming language, developed by Sun Microsystems, Inc., to WWW browser 312 for execution. As will be described in more detail below, aspects of the present invention may be embodied in application programs executed by a host computer, or WWW server 342, such as scripts 344, or may be embodied in application programs executed by computer 300, such as Java™ applications 346. Those skilled in the art will also appreciate that aspects of the invention may also be embodied in a stand-alone application program.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method for securely obtaining data records over a coordinated computer network 1, comprising:
providing a plurality of network members, each network member comprising an internal records database and a node;
providing a network process computer comprising an activity database;
configuring said nodes such that each node has access to said activity database via said network process computer, and only a node associated with a given network member has access to the records database associated with said given network member;
populating said activity database with a plurality of subject activity indicators by at least two of said network members via their associated nodes and a network process operative on said network process computer;
requesting by a target node, via said network process computer, a digital copy of an activity record associated with a subject;
receiving by said target node, one or more digital data-grams from an originator node, said originator node being identified, using one of said subject activity indicators on said activity indicator database, as having access to an internal records database having said activity record;
establishing a temporary secure transport link between said target node to said originator node, under the management of said network process computer; and,
receiving a digital copy of said activity record of said subject by said target node from said originator node via said secure link.

2. The method of claim 1 further comprising terminating said temporary secure transport link once said target node has received said activity record.

3. The method of claim 1 further comprising a super network, said super network comprising a network process module 15 operative on said network process computer 11 and wherein said network process manages a layer on top of a global computer network and said network members.

4. The method of claim 1 wherein said node serves as a gateway for said network member, and said node controls a member activity.

5. The method of claim 3 wherein said network process is capable of initiating assembly of a complete digital copy of an activity record for said subject using a plurality of said subject activity indicators.

6. The method of claim 1 wherein said activity database is located on said network process computer.

7. The method of claim 1 wherein said activity database is located in part on at least on of said nodes.

8. The method of claim 1 said subject activity indicator references a medical record of a subject.

9. The method of claim 1 wherein said subject activity indicator refers to insurance information of a subject.

10. The method of claim 4 wherein said member activity is selected from a group comprising a user access, an access privilege, a record request, a record upload, a record download, a notification, a secure transport or any combination thereof.

11. A computer system comprising;
a node;
a server process enabled on said node capable of managing a member activity; and
a communication process capable communicating with a coordinated computer network.

12. The computer system of claim 11, wherein said member activity is selected from a group comprising a user access, a subject event record, a designation of a subject event identifier, a request for subject event identifier from said coordinated computer network, an assembly of a subject event record from a plurality of subject event identifiers, a billing activity, a maintenance activity or any combination thereof.

13. The computer system of claim 11, wherein said coordinated computer network further comprises a network process that utilizes an activity database for storing one or more subject activity identifiers.

14. The computer system of claim 11, wherein said network process is disposed in part on said node.

15. The computer system of claim 11, wherein said node communicates over a global computer network using a secure transient passage protocol.

16. The computer system of claim 11 wherein said coordinated computer network is further comprised of a plurality of said nodes.
